(19) United States
(12) Patent Application Publication
(10) Pub. No.: US 2011/0226045 A1
(43) Pub. Date: Sep. 22, 2011

(54) LIQUID ANALYSIS SYSTEM

(76) Inventor: Adrian Charles McQuillan, Warrington (GB)

(21) Appl. No.: 12/953,014

(22) Filed: Nov. 23, 2010

Related U.S. Application Data
(60) Provisional application No. 61/264,513, filed on Nov. 25, 2009.

(51) Int. Cl. G01N 1/10; G06K 9/48; H04N 7/18

(52) U.S. Cl. 73/64.56; 382/199; 348/135; 73/863; 348/E07.085

(57) ABSTRACT

Method and apparatus for analysing a fractionated liquid sample received in a vessel having a reference feature, the method comprising capturing an image of the reference feature and an image of a first boundary of a first fraction within the sample, and analysing the captured images to determine the separation of the first boundary from the reference feature. The determined separation can then be used to calculate, for example, the volume of the first fraction associated with the first boundary. Methods and apparatus for aspirating desired volumes from analysed samples are also described.

### CROSS-REFERENCE TO RELATED APPLICATION

This patent application claims the benefit of priority to U.S. Application Ser. No. 61/264,513, filed Nov. 25, 2009, the disclosure of which is incorporated by reference herein in its entirety, and priority to the application is hereby claimed.

### FIELD OF THE INVENTION

The present invention relates to method and apparatus for analysing a fractionated liquid sample of, for example blood, to determine the position of at least one fraction boundary within the sample, which can then be used in subsequent liquid handling processes.

### BACKGROUND OF THE INVENTION

Analysis of liquids, such as blood, often requires the fractionation of a liquid sample followed by aspiration of one or more fractions from within the fractionated sample. Typically, when the liquid being analysed is blood, the blood sample is fractionated within a fractionation vessel (e.g. test-tube) by centrifugation in the presence of an anticoagulant, such as ethylenediaminetetracetic acid (EDTA) giving rise to a sample containing a relatively dense red blood cell fraction, a lower density plasma or serum fraction and a narrow, intervening Buffy coat fraction of intermediate density. Fractionation of blood can also be carried out in the presence of a ‘gel separator’ rather than an anticoagulant, in which case the sample is fractionated into essentially just the red blood cell fraction and the plasma fraction separated by a gel layer which is typically much wider than the Buffy coat layer formed using anticoagulant-mediated centrifugation.

In order to aspirate the desired fraction(s) from a liquid sample it is first necessary to determine the positions of the upper and lower boundaries of the, or each, of the desired fraction(s) within the fractionation vessel and the corresponding fraction volume(s). A convenient first step in this process is to identify the boundaries of each fraction present within the sample which comprise the uppermost surface of the sample and the boundaries or interfaces between the fractions. Once this information is obtained it can then be used to calculate the volume of a target fraction using knowledge of the size of the sample tube.

Manual systems exist in which a blood sample is fractionated within a straight-walled sample tube and the sample tube then supported on a reference platform in front of a calibration chart so that the positions of the fraction boundaries can be determined by visual inspection. Aspiration of the target fraction(s) is then undertaken manually. Such manual methods of fraction determination and aspiration can be inaccurate and are subject to human error, particularly when it is desired to aspirate the relatively narrow Buffy coat. In view of these inherent limitations, automated methods and apparatus have been devised although most still adopt the same general approach of aligning fraction boundaries with a calibration scale provided adjacent the sample, albeit now done automatically, followed by automated aspiration of the desired fraction(s). In spite of certain advantages arising from automation, such systems are susceptible to inaccuracies resulting from certain key steps, such as misalignment of the sample tube with respect to the reference platform and/or calibration scale which can lead to errors in the determination of the position of fraction boundaries and therefore fraction volumes and ultimately to errors in aspiration. One way to address such potential errors in aspiration is to determine fraction boundaries with larger margins of error than would be desirable, however this has the clear disadvantage of leading to a diminution in the accuracy with which a fraction can be aspirated, which is a particular problem when it is desired to aspirate the relatively narrow Buffy coat from a fractionated blood sample.

### SUMMARY OF THE INVENTION

An object of the present invention is to obviate or mitigate one or more of the aforementioned problems.

A first aspect of the present invention relates to a method for analysing a fractionated liquid sample received in a vessel having a reference feature, the method comprising capturing an image of the reference feature and an image of a first boundary of a first fraction within the sample, and analysing the captured images to determine the separation of the first fraction boundary from the reference feature.

The reference feature may be any feature of the vessel that can be identified from an image of at least the corresponding part of the vessel, including but not limited to: the outer surface of the bottom of the vessel; the inner surface of the bottom of the vessel; an indentation or projection defined by or connected to the vessel; a surface mark on the vessel (e.g. printed directly on the vessel or provided on a label adhered to the vessel); or the top of the tube.

The images of the reference feature and the fraction boundary may be contained in a single composite image taken using a suitable device, such as a digital camera, or the images may be separate images taken simultaneously or consecutively using a suitable device.

The determination of the separation of the boundary of one of the fractions in the sample from the reference feature is preferably achieved without reference to a separate physical reference (e.g. a reference scale or plate) that is other than part of or connected to the vessel so as to avoid problems associated with misalignment of the vessel with the external reference. As such, the method of the present invention is more accurate and reliable than prior art methods for analysing samples of fractionated liquids, such as blood samples fractionated using an anticoagulant (e.g. EDTA), a blood separation agent (e.g. Ficoll-Paque®), or in the presence of a gel separator, as are known in the art.

A second aspect of the present invention, which may be useful in aspirating the red blood cell layer from a fractionated blood sample, relates to a method of aspirating liquid from a fraction of a fractionated liquid sample within a vessel having a reference feature, the method comprising capturing an image of the reference feature and an image of a first boundary of a first fraction within the sample, analysing the captured images to determine the separation of the first fraction boundary from the reference feature, determining a volume of the first fraction with reference to the separation of the first boundary from the reference feature, and aspirating said liquid from the first fraction.

A third aspect of the present invention, which may be useful in aspirating the plasma layer from a fractionated blood sample, relates to a method of aspirating liquid from a fraction of a fractionated liquid sample within a vessel having a reference feature, the method comprising capturing an image of the reference feature and an image of a first boundary of a first fraction within the sample, the method further comprising capturing a further image of a second boundary of the first fraction within the sample, analysing the captured images to determine the separation between the first and second boundaries, determining a volume of the first fraction with reference to the separation of the first and second boundaries of the first fraction, and aspirating said liquid from the first fraction.

A fourth aspect of the present invention, which may be useful in aspirating the Buffy coat layer from a fractionated blood sample, relates to a method of aspirating liquid from a fraction of a fractionated liquid sample within a vessel having a reference feature, the method comprising capturing an image of the reference feature and an image of a first boundary of a first fraction within the sample, the method further comprising capturing a first further image of a second boundary between the first fraction and an adjacent fraction within the sample, capturing a second further image of a third boundary between said adjacent fraction and a further fraction within the sample, analysing the captured first and second further images to determine the separation of the second and third boundaries from the reference feature, determining the difference between the separation of the second and third boundaries from the reference feature, using said difference to calculate the separation of the second boundary from the third boundary, calculating the volume of said adjacent fraction from the calculated separation of the second boundary from the third boundary, and aspirating said liquid from said adjacent fraction.

In a preferred embodiment of the fourth aspect of the present invention, which may be useful in aspirating the Buffy coat layer from a fractionated blood sample, the method comprises capturing an image of the reference feature and an image of a first boundary of a first fraction within the sample, the method further comprising capturing a first further image of a second boundary between second and third fractions within the sample, capturing a second further image of a third boundary between first and third fractions within the sample, analysing the captured first and second further images to determine the separation of the second and third boundaries from the reference feature of the vessel, determining the difference between the separation of the second and third boundaries from the reference feature of the vessel, using said difference to calculate the separation of the second boundary from the third boundary, calculating the volume of the third fraction from the calculated separation of the second boundary from the third boundary, and aspirating said liquid from the third fraction.

It will be appreciated that the initial steps in the second, third and fourth aspects of the present invention prior to determining the fraction volume and aspirating are generally in accordance with the first aspect of the present invention. Any of the preferred or optional features of the first aspect of the invention set out below may be applied to the method forming the second, third and/or fourth aspects of the present invention.

The method according to the first aspect preferably further comprises determining the volume of said fraction with reference to the separation of the fraction boundary from the reference feature, as forms part of the method according to the second aspect of the invention. In the case that the fraction in question is the lowermost fraction within the fractionated sample (i.e. the fraction closest to the bottom surface of the vessel), only the separation of the first fraction boundary from the reference feature (e.g. the bottom inner surface of the vessel) may be required to determine the volume of the fraction. Where the fraction in question is not the lowermost fraction within the fractionated sample (i.e. other than the fraction closest to the bottom surface of the vessel), determination of the volume of the fraction may require the identification of a further boundary associated with the fraction being analysed, and possibly one or more further fraction boundaries within the sample. Accordingly, in those cases, it is preferred that at least one further image is captured of the or each further boundary as mentioned in the third and fourth aspects so that the separation between the two boundaries of the fraction in question, and therefore the volume of the fraction, can be accurately calculated. The images of the fraction boundary and the or each further fraction boundary may be comprised in a single composite image or in two or more separate images.

The methods of the first and/or second aspects of the invention preferably further comprise the step of capturing at least one further image of at least one further fraction boundary, and analysing the captured image(s) to determine the separation of the or each further fraction boundary from the reference feature. Where the first fraction boundary and further fraction boundary relate to the same fraction within the sample, the method preferably further comprises determining the volume of that fraction with reference to the separation of the first fraction boundary from the further fraction boundary, the position of each boundary having been determined with reference to the reference feature. Where the first fraction boundary and further fraction boundary relate to different fractions within the sample, the method preferably further comprises determining the volume of the fractions between the boundaries with reference to the separation of the first fraction boundary from the further fraction boundary, the position of each boundary having been determined with reference to the reference feature.

The image of the fraction boundary and optionally one or more further fraction boundaries is preferably obtained whilst the sample is illuminated from generally the opposite side of the sample to the side of the sample viewed while capturing images.

The illumination may be general illumination in that it is directed generally towards the sample as a whole, rather than being specifically directed towards a portion of the sample, or may be directed illumination that is directed towards the sample or a specific region of the sample from a position that is offset from the level of the sample being illuminated. As a further alternative, both types of illumination may be used consecutively to catch images of different fraction boundaries within the sample and/or identification features associated with the vessel. The directed illumination is preferably provided from above or below the sample or region of the sample being illuminated thereby. This can be advantageous in avoiding reflection of the focussed illumination by the sample vessel and/or the region of the sample being focussed upon. This has been found to be particularly advantageous when the region in question is the Buffy coat of a blood sample fractionated using an anticoagulant, such as EDTA, since the Buffy coat can be highly reflective. Further, the directed illumination may be focussed upon one or more regions of the sample, e.g. one or more fraction boundaries or areas between fraction boundaries or regions between fraction boundaries.

The general illumination is preferably provided by a suitable light source, such as one or more LEDS, via a diffuser or the like. The colour of the general illumination should be selected based upon the sample being analysed so as to provide the required degree of contrast between the or each fraction boundary and the sample as whole. For example, in a first preferred embodiment in which the method is being used to sample human or animal blood, which has been fractionated using EDTA, it is particularly preferred that the general illumination is red in colour as this has been found to provide good contrast between the lower red blood cell layer and the upper plasma or serum layer. In this embodiment, the fraction boundary captured in one image may be the top surface of the red blood cell layer, also corresponding to the lower surface of the Buffy coat, and the further fraction boundary may be the meniscus at the top surface of the plasma or serum layer. Further, the position of the reference feature may also be captured in an image, during the period of general illumination.

The directed illumination is preferably provided by one or more light sources, such as light emitting diodes (LEDs) or the like, which are capable of providing bright, directed light, which may be focussed. As with the general illumination, the colour of the directed illumination should again be chosen to afford good contrast between the fraction boundaries being analysed. In the preferred embodiment described above where an EDTA fractionated sample of blood is being analysed, it is preferred that the directed illumination is red in colour. The directed illumination can be directed towards the anticipated location of the upper and lower boundaries of the Buffy coat in between the red blood cell layer and the plasma or serum layer. Additionally or alternatively the directed illumination can be directed so as to illuminate a region of the sample encompassing, more preferably approximately matching, the anticipated height of the Buffy coat layer or other fraction within the sample. An image taken of the sample while the directed illumination is activated, but the general illumination is deactivated, therefore affords a convenient means for determining the separation of the upper and lower boundaries of the Buffy coat from the reference feature, which can then be used to calculate the volume of the Buffy coat, and/or the volume of the upper plasma or serum layer when combined with the separation of the top surface of the upper layer from the reference feature, which may be obtained during the period of general illumination.

Determination of the volume of a fraction within a sample may be achieved using predetermined calibration data. The calibration data may provide correlations between the separation of fraction boundaries from the reference feature associated with the sample vessel and the volume of the fractions associated with those fraction boundaries. The calibration data is preferably stored in a look-up table associated with apparatus configured to perform a method according to the present invention.

In a preferred embodiment the images of the reference feature and the first fraction boundary may be captured during general illumination of at least the first fraction within the sample and the reference feature, or may be directed at substantially the entire depth of the liquid sample within the vessel. This method may further comprise determining the volume of the first fraction with reference to the separation of the first boundary from the reference feature. In this embodiment, the first fraction may be the red blood cell fraction of a blood sample fractionated in the presence of EDTA or a gel separator, and the first boundary may be the upper surface of the red blood cell layer which is at the interface between the layer of red blood cells and a Buffy coat layer or a gel layer.

In another preferred embodiment, once the image of the first boundary has been captured, a further image is captured of a second boundary of the first fraction and the separation between the first and second boundaries of the first fraction determined. In this embodiment the first fraction may for example be the Buffy coat layer within a fractionated blood sample. The images of the first and second boundaries may be contained in a single composite image or may be separate images taken simultaneously or consecutively. The images of the first and second boundaries of the first fraction are preferably captured during directed illumination of said first and second boundaries within the sample. The directed illumination of one (or more) fraction boundaries is preferably provided by one or more (e.g. two) light sources offset from the fraction boundary or boundaries, and arranged to direct light onto the fraction boundary or boundaries, e.g. to direct light downwardly and/or upwardly. The directed illumination illuminates the sample across the range of anticipated positions of the one or more fraction boundaries or across the anticipated height of the fraction under illumination. When two light sources are used, one may be focussed towards the first fraction boundary and the other may be focussed towards the second fraction boundary. This is advantageous when the first fraction is the Buffy coat layer since this layer is known to be particularly reflective towards light shone on to it, and so using offset illumination, e.g. downward or upward illumination, reduces or eliminates problems that may otherwise arise from reflected light obscuring details in the captured images of the boundaries, if the illumination is provided level with the Buffy coat layer. This method may further comprise determining the volume of the first fraction, e.g. the Buffy coat, with reference to the separation of the first and second boundaries of the first fraction. This may be useful when wishing to aspirate the Buffy coat from a fractionated blood sample.

In a further alternative preferred embodiment, once the image of the first boundary has been captured, a first further image is captured of a second boundary between second and third fractions within the sample, and the separation of the second boundary from the reference feature determined. In this embodiment the sample may be a blood sample fractionated such that the first fraction is a layer of plasma or serum, the second fraction is a layer of red blood cells and the third fraction is a Buffy coat layer. In this case, the first boundary may be the uppermost surface of the plasma layer and the second boundary may be the boundary or interface between the layer of red blood cells and the Buffy coat. The images of the first and second boundaries may be contained in a single composite image or may be separate images taken simultaneously or consecutively. The images of the first and second boundaries are preferably captured during general illumination of at least the first and second fractions within the sample and the bottom of the vessel. The general illumination may be directed at substantially the entire depth of the liquid sample within the vessel. The volume of the second fraction may be calculated from the calculated separation of the second boundary from the reference feature.

In the present alternative preferred embodiment a second further image may be captured of a third boundary between the first and third fractions within the sample, and the separation of the third boundary from the reference feature determined. In the exemplary application mentioned above, in which the first boundary is the uppermost surface of the plasma layer and the second boundary is the boundary between the layers of red blood cells and Buffy coat, the third boundary is preferably the boundary or interface between the Buffy coat and the plasma layer. The images of the second and third boundaries may be contained in a single composite image or may be separate images taken simultaneously or consecutively. The second further image may be captured during directed illumination of said third boundary within the sample, preferably provided by at least one light source arranged to direct light from an offset position, e.g. downwardly or upwardly on to said third boundary.

In an embodiment of the present invention, an image may capture a fourth fraction boundary, which may be the lowermost boundary of the lowermost fraction, i.e. the boundary between the lowermost fraction and the inner bottom surface of the vessel. In the exemplary application that the lowermost fraction is the layer of red blood cells, the fourth boundary is preferably the boundary between the red blood cell layer and the inner bottom surface of the vessel.

The difference between the separation of the first and third boundaries from the reference feature may be determined and used to calculate the separation of the first boundary from the third boundary, and then optionally the volume of the first fraction, e.g. the plasma or serum layer, may be determined from the calculated separation of the first boundary from the third boundary.

Alternatively or additionally, the difference between the separation of the second and third boundaries from the reference feature may be determined and used to calculate the separation of the second boundary from the third boundary, and then optionally the volume of the third fraction, e.g. the Buffy coat, may be determined from the calculated separation of the second boundary from the third boundary.

The vessel holding the sample may be provided with a vessel identification feature (e.g. a vessel identification mark), such as a barcode, which can be captured within a dedicated image, or in a composite image also containing one or more reference features and/or a fraction boundary or boundaries. Capture of an image of the identification mark on the vessel may be facilitated by the provision of a mirror, such that an image captured from a first side of the vessel may comprise an image of the identification mark provided on a different side of the vessel and viewed within the image by reflection in the mirror. Alternatively, capture of an image of the identification mark on the vessel may be facilitated by rotation of the vessel before or after imaging of the sample. In a yet further alternative, the vessel may be provided with a radio frequency identification (RFID) tag, which may be read by an RF reader to identify the vessel, and the readout associated with the captured image(s).

A vessel identification feature may additionally or alternatively be provided separately to the vessel, for example, on a support associated with the particular type of vessel being used. The vessel identification feature may be used to identify dimensions of the vessel, such as its diameter, which could for example be used in the calculation of the volume of one or more of the fractions contained in the sample once combined with the calculated separation of the upper and lower boundaries of the or each fraction. The method according to the first aspect of the present invention may further comprise recognising a vessel type identification feature within a captured image identifying the type of the vessel, and using data associated with said identification feature in the calculation of the volume of a fraction within the fractionated sample received in the vessel. The identification feature may additionally or alternatively be used to identify a particular sample for tracking of that sample during subsequent processing and/or storage.

A fifth aspect of the present invention relates to apparatus for analysing a fractionated liquid sample, the apparatus comprising a support for a vessel having a reference feature containing said fractionated liquid sample, an image capture device arranged to capture an image of the reference feature (e.g. bottom surface) and an image of a first boundary of a first fraction within said sample, and an image analysis device adapted to analyse the captured images and determine the separation of the first fraction boundary from the reference feature.

The apparatus according to the fifth aspect of the present invention is eminently suitable to put into effect the method according to the first aspect of the present invention. As such, features of the apparatus of the fifth aspect can be used to effect steps of the method according to the first aspect of the present invention.

The apparatus of the fifth aspect may further comprise an alignment block to aid correct alignment of the vessel containing the sample relative to the image capture device. The alignment block may incorporate guides or jaws arranged to abut a lower section of the vessel whilst the vessel is supported by the support. The jaws are preferably spaced apart sufficiently to define a clearance through which the image capture device can view the bottom surface of the vessel containing the sample. The alignment block may further incorporate a mirror arranged to facilitate capture of an identification feature associated with the side of the vessel.

The image analysis device is preferably adapted to calculate the volume of the fraction whose one or more boundaries have been imaged and whose separation from the reference feature has been determined.

A sixth aspect of the present invention provides apparatus for analysing a fractionated liquid sample and aspirating liquid from said sample, the apparatus comprising a support for a vessel having a reference feature containing said fractionated liquid sample, an image capture device arranged to capture an image of the reference feature and an image of a first boundary of a first fraction within said sample, an image analysis device adapted to analyse the captured images and determine the separation of the first fraction boundary from the reference feature, and an aspiration device to aspirate a desired amount of liquid from said first fraction.

The apparatus according to the sixth aspect of the present invention is eminently suitable to put into effect the methods according to the second, third and fourth aspects of the present invention.

With regard to the apparatus according to the fifth or sixth aspects of the present invention, the image capture device is preferably adapted to capture one or more further images of one or more further fraction boundaries within the liquid sample. The image analysis device is preferably adapted to analyse one or more of the further captured images to determine the separation of the one or more further fraction boundaries from the reference feature associated with the vessel holding the sample.

The apparatus of the fifth or sixth aspects may further comprise a light adapted to provide general illumination directed generally towards the sample contained in the vessel and/or directed illumination adapted to provide illumination directed towards a specific region of the sample, from a position that is offset from the level of the region of interest.

Non-limiting embodiments of the present invention will now be described by way of example only and with reference to following Figures in which,

### BRIEF DESCRIPTION OF THE DRAWINGS

FIG. 1 is a schematic perspective view of boundary identification apparatus to analyse a fractionated blood sample and then aspirate target fractions from the sample which incorporates apparatus according to the present invention to identify boundaries between fractions within the sample;

FIG. 2 is a schematic perspective view of key components of the boundary identification apparatus of FIG. 1;

FIG. 3a is a schematic side view of the key components shown in FIG. 2;

FIG. 3b is a schematic side view of the key components shown in FIG. 2 viewed from the opposite side to FIG. 3a;

FIG. 4 is a schematic end view of the key components shown in FIG. 2;

FIG. 5 is a schematic plan view of the key components shown in FIG. 2;

FIG. 6 is a schematic cross-sectional view through a fractionated sample supported by one of the key components of FIGS. 2 to 5;

FIG. 7a is a schematic side view of the sample shown in FIG. 6 annotated to highlight regions of interest of the sample (shown dotted) inspected during a first step in the optical analysis of the sample;

FIG. 7b is a schematic side view of the sample shown in FIG. 6 annotated to highlight a region of interest of the sample (shown dotted) inspected during a second step in the optical analysis of the sample; and

FIG. 8 is a schematic side view of a sample similar to that shown in FIG. 7 but rotated through approximately 90° so that a bar code associated with the sample can be inspected during optical analysis of the sample, according to an alternative embodiment of the method of the present invention.

### DETAILED DESCRIPTION

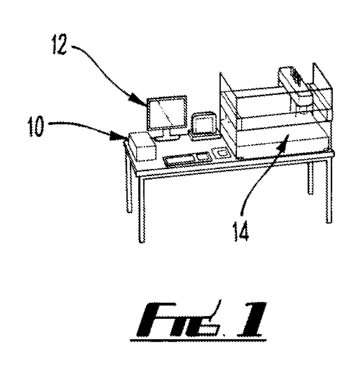

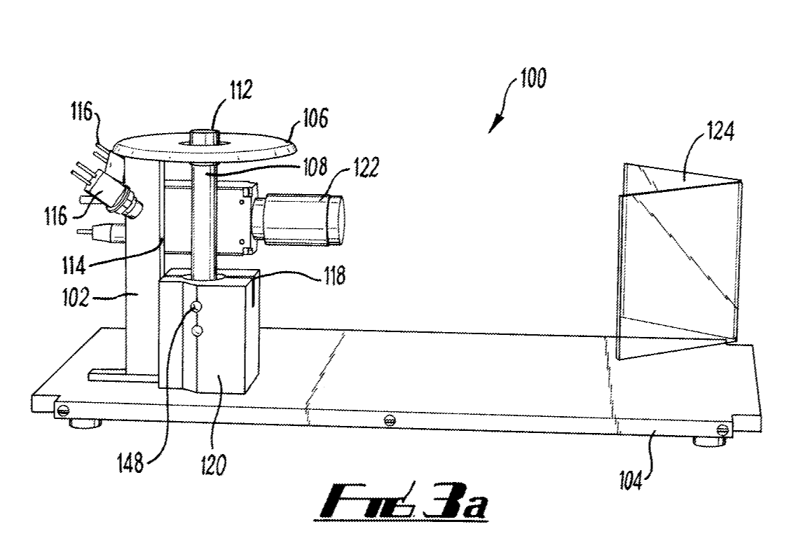

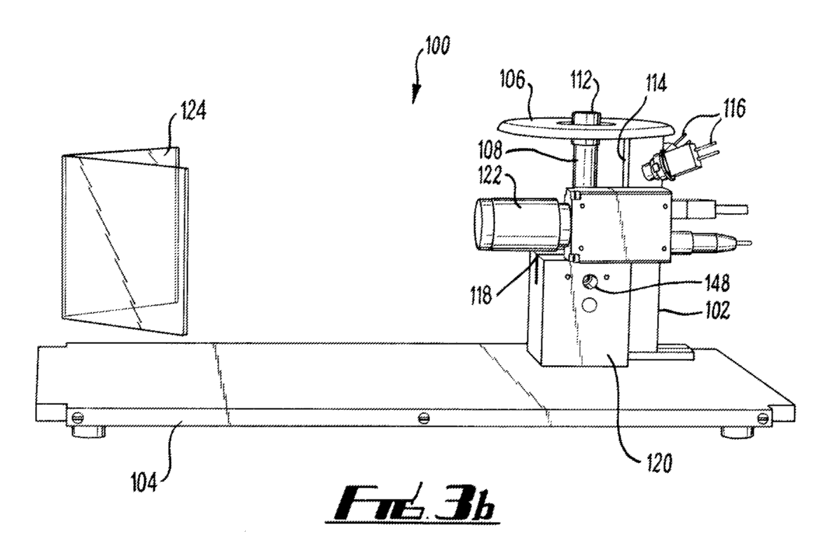

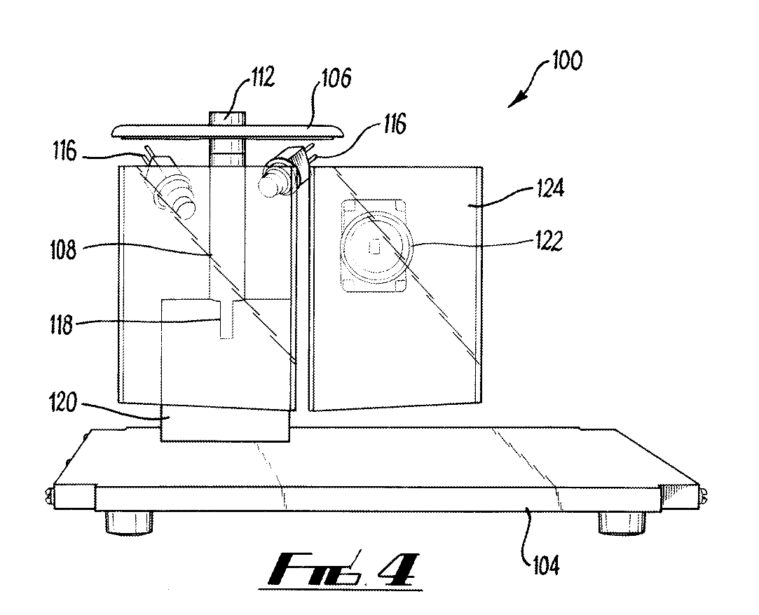

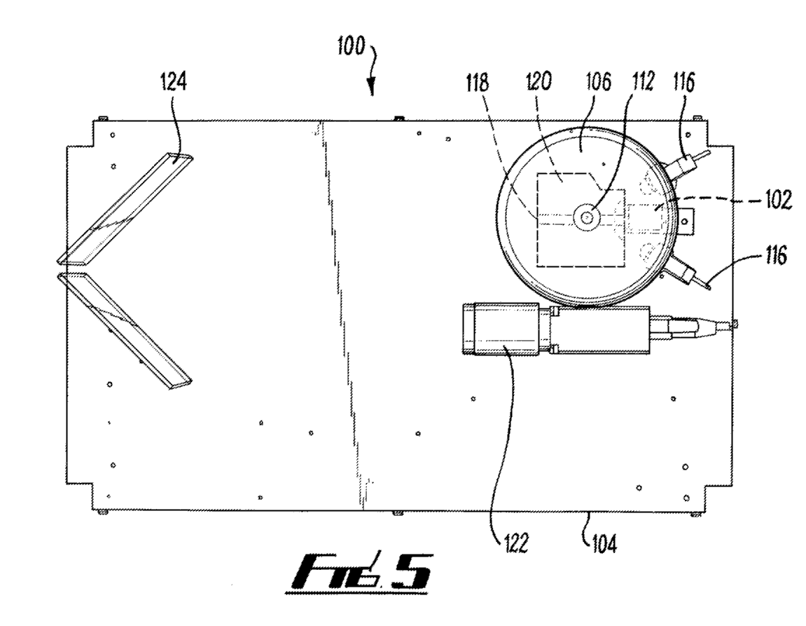

FIG. 1 illustrates apparatus suitable for analysing fractionated samples of fluids so as to identify boundaries between the fractions within the sample and accurately aspirate one or more of said fractions. The apparatus shown in FIGS. 1 to 8 is described in terms of its use to process a fractionated blood sample, but it will be appreciated that the apparatus can be used to process many different types of fractionated fluid sample, and is not limited to just blood samples. The apparatus described herein with reference to FIGS. 1 to 8 is arranged to process a sample of blood which has been centrifuged with an anticoagulant, such as ethylenediaminetetraacetic acid (EDTA), so as to split a blood sample into three fractions: a relatively less dense plasma or serum layer; a more dense red blood cell layer; and an intermediate Buffy coat layer which typically represents no more than around 1% of the total volume of the fractionated sample but which contains the majority of the white blood cells and platelets present in the sample. Among other applications, the apparatus shown in FIGS. 1 to 8 can also be used to process blood samples that have been fractionated using a gel separator to more clearly separate the plasma and red blood cell layers. Further, the apparatus shown in FIGS. 1 to 8 can also be used to process blood samples that have been fractionated into more (or fewer) than three fractions, e.g. by use of the blood separation agent Ficoll-Paque®.

Referring now to FIG. 1, there is shown a sample analyser unit 10 for optically determining boundaries between fractions within a fractionated blood sample. The analyser unit 10 is operatively linked via a computer 12 to an automated liquid handling unit 14 in which aspiration of target fractions within a plurality of samples can take place, the aspirated fractions then being available for further analysis.

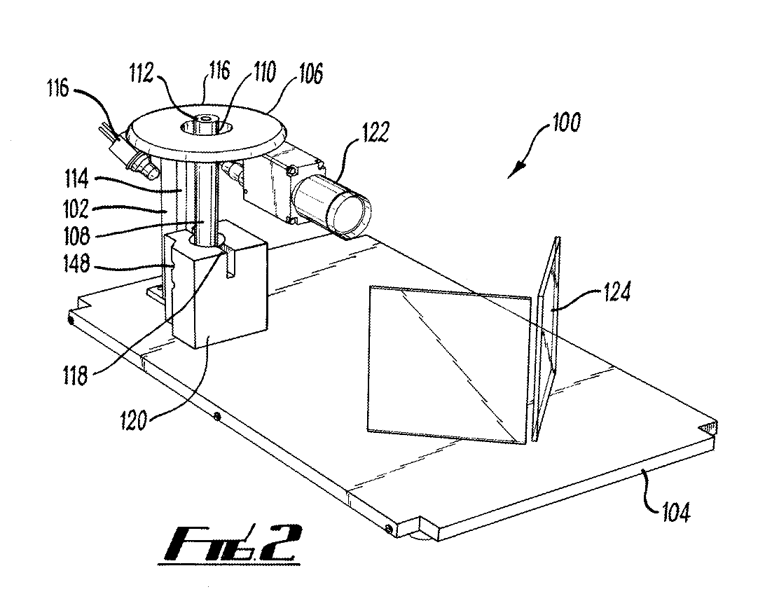

FIGS. 2 to 5 show from different perspectives key internal components of the sample analyser unit 10 in greater detail, which shall hereinafter be referred to as boundary identification apparatus 100. The apparatus 100 includes an upright aluminium channel supporting a block of LEDs 102 fixed to a base plate 104, which also supports many of the other key components of the apparatus 100 in an accurately defined arrangement relative to one another as described more fully below. The base 104 also provides mechanical protection to the other components of the apparatus 100, prevents extraneous light entering the bottom of the apparatus 100 and provides a convenient means for stably mounting the apparatus on horizontal surfaces such as bench tops and the like. A top cover (not shown) is provided which connects securely to the base 104 to provide additional mechanical protection for the components of the apparatus 100 and prevent outside light entering the apparatus 100.

A boss 106 is provided which defines a central opening within which is removably received a sample tube 108 containing a fractionated blood sample. The tube 108 is aligned within the boss 106, for example by the periphery of the central opening defined by the boss 106 engaging a tube cap 112. A single boss 106 can be used to accommodate a range of different tube 108 sizes, or alternatively, dedicated bosses 106 can be selected to be used with specific sizes or types of tube 108. The boss 106 is preferably removably mounted within the apparatus 100, so that it can be conveniently replaced and/or subjected to routine maintenance as often as required. The dimensions of the boss 106, including importantly the central opening, are accurately defined to prevent extraneous light from entering the apparatus 100, while still allowing tubes 108 to be handled easily during insertion and subsequent removal from the apparatus 100. A preferred way in which this is achieved is illustrated in the specific embodiment shown in FIGS. 2 to 5 in which the boss 106 defines a downwardly inclined tapered section encircling the central opening thereby allowing users to easily grip and manipulate tubes 108 that are partly or fully received within the opening.

A vertically extending diffuser 114 is connected to the side of the LED block facing the sample tube 108 and converts the light from the LEDs into general back-illumination of a red colour from behind the tube 108 such that the general illumination extends vertically from at least the bottom of the tube 108 to the anticipated top of the sample within the tube 108, preferably up to the underside of the tube cap 112. The LED block provides a consistent source of light over a long operational lifetime. Red light is preferred, particularly for fractionated blood samples, since in images of such samples red light has been found to provide a good contrast between layers within the sample. In the present exemplary embodiment in which a fractionated blood sample is analysed, the use of red light causes the red blood cells in the lowermost fraction to appear essentially black when viewed in an image of the sample captured by the apparatus 100, while the plasma in the uppermost fraction appears near white. The intensity of the light emitted by the LED block can be pre-selected, or adjusted by a user for a particular sample to provide an image suitable for analysis.

Also mounted on the base 104 is a pair of downward orientated red LED spot lights 116 arranged to provide directed illumination directed downwardly towards the anticipated upper and lower boundaries of the Buffy coat layer of the fractionated sample within the tube 108. One spot light 116 is arranged to illuminate a region of the sample corresponding with the range of expected positions of the upper boundary and the other spot light 116 is arranged to illuminate a region of the sample corresponding with the range of expected positions of the lower boundary of the Buffy coat layer. In this way the two LEDs 116 illuminate the anticipated height of the Buffy coat layer. Again, red light is preferred since it has been found to provide good contrast between the Buffy coat layer and the neighbouring layers. Positioning the spot lights 116 behind the sample tube 108 also reduces unwanted reflections from the Buffy coat layer which might otherwise disrupt visualisation of the Buffy coat layer. When the sample being analysed has been fractionated using a gel separator rather than an anticoagulant, such as EDTA, or a blood separation agent, such as Ficoll-Paque®, the spot lights 116 do not need to be used.

A lower portion of the tube 108 is aligned between a set of alignment jaws 118 defined by an alignment block 120. The jaws 118 define a generally cylindrical bore for receipt of the lower end of the tube 108 such that the tube 108 is guided during insertion into the apparatus 100 and subsequently correctly vertically aligned with respect to the other components of the apparatus 100. The alignment block 120 supports the tube 108. The alignment block 120 also defines a transversely extending aperture 148 which opens into the space between the jaws 118 occupied by the lower end of the tube 108. The presence of a tube within the jaws 118 of the alignment block 120 may be detected by a digital camera 122. Alternatively, an LED (not shown) is provided to one side of the alignment block 120 and is arranged to emit light through the aperture 148 such that when the sample tube 108 is inserted into the boss 106 and its lower end correctly located between the jaws 118 the light from the LED can no longer pass through aperture 148, thereby providing an optical means of determining that the tube 108 has been correctly inserted. The presence of light passing through the aperture 148 may be detected by a sensor (not shown) positioned on the opposite side of the alignment block 120 to the LED, or it may be detected by the camera 122 through use of a mirror suitably aligned with respect to the aperture 148.

The base 104 supports the digital camera 122 and an arrangement of front surface mirrors 124 which are positioned to provide the camera 122 with a side view of the tube 108. The base 104 is used to accurately define the relative positioning of the camera 122, mirrors 124 and alignment block 120 so as to ensure that the camera 122 can capture images of the sample and the sample tube 108 accurately and reproducibly. The use of the mirrors 124 enables the camera 122 to be located alongside the tube 108 which reduces the overall size of the apparatus 100. In a preferred embodiment the camera 122 uses a monochrome CCD sensor with a resolution of 1024×768 pixels so as to provide a height resolution at the tube 108 of approximately 0.1 mm. Other sensors can be used as appropriate, for example, sensors with greater resolution may be used as the associated cost of such equipment falls over time and/or the need for accuracy overtakes cost. Moreover, while monochrome is preferred to colour since monochrome images are currently easier to process than colour images, in alternative embodiments, it may be desirable to use a colour sensor.

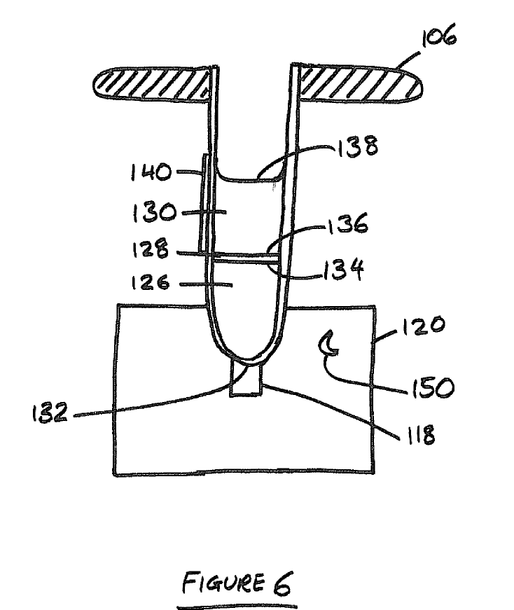

FIG. 6 shows a cross-sectional view through the fractionated blood sample contained within the tube 108. The sample has been centrifuged using the anticoagulant EDTA and so has separated out into three fractions, a lower red blood cell containing fraction 126, an intermediate Buffy coat layer 128, and an upper plasma/serum fraction 130. The bottom outer surface of the sample tube 108, i.e. the lowermost outer surface of the tube 108, is identified by the numeral 132. Between the red blood cell fraction 126 and the Buffy coat 128 is the lower boundary of the Buffy coat 134. Between the Buffy coat and the plasma fraction is the upper boundary of the Buffy coat 136. The upper boundary of the plasma fraction 130 is defined by the meniscus 138. The tube 108 is provided with an identification barcode 140. The tube is advantageously transparent, or may have a visualisation window for viewing fraction boundaries.

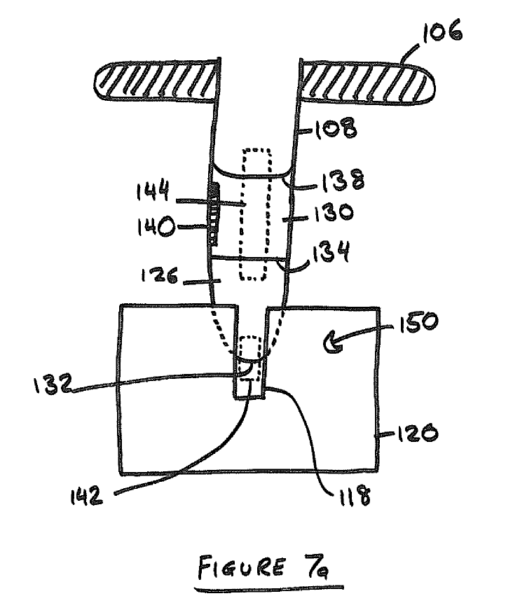

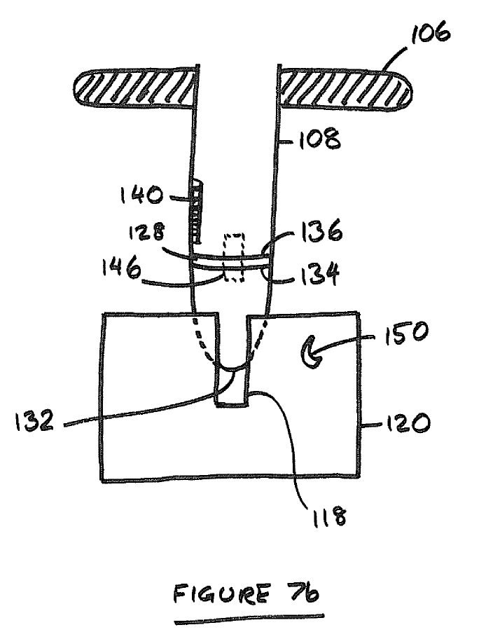

Different alignment blocks 120 are used with different sizes of sample tubes 108 to ensure that the generally cylindrical bore between the alignment jaws 118 provides a close fit to the size of tube 108 being used. Optionally, a block identification mark 150 may be provided on the alignment block 120 such that the size of the block 120 and, in turn, the size of the tube 108 may be determined from an image captured by the camera 122. In the preferred embodiment depicted in FIGS. 6 and 7, the block identification mark 150 is provided by a shaped aperture extending through the block 120 which is backlit by a light source, such as an LED.

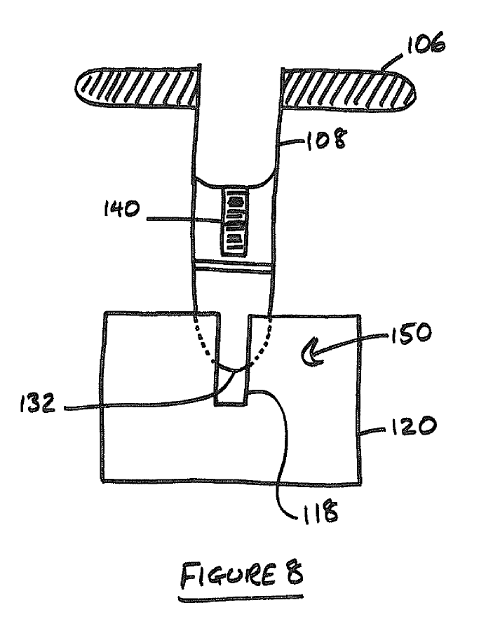

Operation of the apparatus 100 as described above with reference to FIGS. 1 to 6 will now be described with reference to a first embodiment illustrated in FIGS. 7a, 7b, and an alternative embodiment illustrated in FIG. 8.

The upper portion of a sample tube 108 is received and aligned by the boss 106, with the lower portion of the tube 108 aligned and supported between the jaws 118 of the alignment block 120. The sample tube 108 holds fractions of a fractionated blood sample, composed of a red blood cell fraction 126, a Buffy layer 128 and a plasma fraction 130. Only the red blood cell layer 126 and plasma layer 130 are visible in FIG. 7a and only the Buffy coat layer 128 is visible in FIG. 7b.

FIGS. 7a and 7b illustrate side views of the sample tube 108 as presented to the camera 122 via the mirrors 124. The camera 122 captures a first image during a period of general backlit illumination of the tube 108 by the red LED block behind the diffuser as shown in FIG. 7a. The first image incorporates a bottom image portion 142 that includes the outer bottom surface 132 of the tube 108 and also preferably incorporates an upper image portion 144 that includes at least one of the top of the red blood cell layer 134 and the meniscus 138 at the top of the plasma or serum layer 130. In this specific embodiment outer bottom surface 132 of the tube 108 is used as the reference feature of the tube 108 with respect to which separations of fraction boundaries are determined. The camera 122 captures a second image during a period of downwardly directed illumination provided by the pair of LED spot lights 116 as shown in FIG. 7b, which includes at least a central image portion 146 incorporating the lower and upper boundaries of the Buffy coat 134, 136. As mentioned above in relation to FIGS. 2 to 5, the LEDs 116 are arranged so that one is offset slightly with respect to the other such that the downward illumination provided by the LEDs 116 during capture of the second image is directed towards the ranges of anticipated positions of the lower and upper boundaries of the Buffy coat 134, 136, making them easier to identify and locate accurately in the second image, whilst ensuring that the full depth of the Buffy coat is illuminated.

During capture of the first or second image, or alternatively during capture of a third image, an image is captured that includes the barcode 140 (i.e. the identification feature). This is facilitated by the provision of a mirror (not shown) adjacent to the tube 108, and which is connected to the base 104 (alternatively the mirror may be connected to the alignment block 120). In this way, the first and/or second images can be composite images including both boundary layers of the sample and/or a reference feature (e.g. the outer bottom of the tube) and the unique barcode for that sample in that particular tube. This may be advantageous for example where it is later desired to validate an earlier result since both the sample image and identification information are contained in a single composite image. Advantageously the image of the barcode may be captured prior to, or simultaneously with, the capture of images of fraction boundaries, e.g. to confirm the identity of the inserted tube 108.

Alternatively to the preferred embodiment in which the mirror is provided to facilitate the reading of the barcode 140 by the camera 122, FIG. 8 illustrates an alternative embodiment, in which the boss 106 is rotatable. After the first two images have been captured, as described above, the rotatable boss 106 axially rotates the tube 108 to present the barcode 140 into the side view visible to the camera 122, as shown in FIG. 8. The camera 122 then captures a third image including the barcode 140.

Image analysis software is then used to determine the positions of the bottom outer surface 132 (i.e. the reference feature) of the tube 108, the lower and upper fraction boundaries of the Buffy coat 134, 136 and the upper fraction boundary 138 of the plasma fraction 130. The software determines the separation of each fraction boundary 134, 136, 138 from the bottom outer surface 132 of the tube 108 in terms of a number of pixels within each of the first two images, and correlates the separation of each fraction boundary with volumetric calibration information stored in a look-up table in order to determine the volumes of the fractions of the sample. In an alternative embodiment, the software calculates distances in mm, based on the determined pixel values, and a calculation based upon the dimensions of the tube can be performed to determine the volumes of fractions of the sample. This calculation can be carried out in a number of different ways but can be conveniently achieved by the use of look-up tables.

Information to identify and characterise the sample and the tube 108 are derived from the captured images of the barcode 140 and the block identification mark 150, and this information is correlated and stored for future use by the liquid handling apparatus 14 shown in FIG. 1. The volumes of the blood fractions 126, 128 and 130 can be determined from the measured heights above the bottom of the tube 132 of the fraction boundaries 134, 136 and 138, and this information can then be used by the liquid handling apparatus 14 to aspirate a target fraction from within the sample.

In a preferred method of aspirating plasma from the fractionated blood sample, the plasma fraction 130 is aspirated to a depth just above the upper boundary 136 of the Buffy coat fraction 128 and in doing so a volume of liquid that is slightly less than the calculated volume of the plasma fraction 130 is removed. This is intended to ensure, as far as possible, that the aspirate is pure blood plasma.

In a preferred embodiment for removing the Buffy coat fraction 128 the plasma may be aspirated as described above and then, in a second step, the Buffy coat fraction 128 is aspirated to a depth just below the lower Buffy coat boundary 134, such that a volume slightly greater than the volume of the Buffy coat fraction 128 is aspirated. In this way, the amount of Buffy coat aspirated is maximised. Alternatively, it would be possible to aspirate from within the Buffy coat fraction 128 directly without having first removed the plasma fraction 130.

Aspiration of any fraction within a fractionated sample may complete within a fraction just above the lower or upper Buffy coat boundary 134, 136, or close to the internal bottom surface of the tube 108, and a volume slightly less than the calculated fraction volume may be aspirated, thereby removing a maximal sample from within a single fraction. In a further alternative embodiment, aspiration may complete just below the lower or upper Buffy coat boundary 134, 136, or close to the internal bottom surface of the tube 108 and a volume slightly greater than the volume of the fraction above the boundary or internal bottom surface of the tube is aspirated, thereby removing the entirety of the fraction above the boundary or internal bottom surface of the tube 108.

It is important to be able to accurately and reproducibly determine boundaries between layers within a fractionated sample to facilitate accurate liquid handling. In view of the need for precision in the readings taken during sample image analysis, particularly, when one considers the narrowness of the Buffy coat, great care must therefore be taken to minimise any potential for error. Significant sources of error arise, for example, from misplacement or misalignment of a sample tube within apparatus used to analyse the sample 100 which uses a point of reference separate to the tube, such as a scale behind the sample and/or a reference platform from which to take readings.

The sample analysis process can be repeated as many times as required simply by removing a sample that has been analysed using the apparatus 100 and inserting a new sample. The apparatus 100 is eminently suitable to receive samples manually, thereby keeping hardware costs down, or alternatively, using an automated system to increase throughput by removing the requirement for human inputting of samples. Advantageously, an automated system can be integrated with other automated sample handling and/or analysis apparatus.

When the apparatus 100 is used to analyse a blood sample which has been fractionated using a gel separator, as mentioned above, the LED spot lights 116 do not need to be used. As such, the above described process can be modified for use with a gel separated sample so as to illuminate the sample with the LED block behind the diffuser 114, capture of an image of the illuminated sample to detect the bottom of the sample tube and the meniscus at the top of the plasma or serum layer, calculation of the position of the meniscus relative to the bottom of the tube in the same way as hereinbefore described, and calculation of the separation of the boundaries of the gel layer from the bottom of the tube using a predetermined value for the depth of the gel layer, which is possible because a known volume of the gel is typically provided in sample tubes which use such gels at the point of manufacture. Alternatively, the bottom of the gel layer and the meniscus at the top of the plasma or serum layer, can be determined using the method described above for an EDTA-fractionated sample and then the positions of the gel layer and meniscus relative to the bottom of the tube calculated in the same way as the EDTA-fractionated sample.

The apparatus 100 of the present invention can also be used to analyse EDTA fractionated blood samples containing fat which can potentially obscure the Buffy coat leading to difficulties in image analysis. In the event that the apparatus 100 fails to accurately identify the Buffy coat from the second image illuminated using the LED spot lights 116 then position of the Buffy coat can be estimated using data derivable from the first image illuminated using the LED block behind the diffuser 114.

Various features of the invention are set forth in the following claims.

What is claimed is:

1. A method for analysing a fractionated liquid sample received in a vessel having a reference feature, the method comprising capturing an image of the reference feature and an image of a first boundary of a first fraction within the sample, and analysing the captured images to determine the separation of the first fraction boundary from the reference feature.

2. A method according to claim 1, wherein the reference feature comprises a bottom outer surface of the vessel.

3. A method according to claim 1, wherein the reference feature comprises a projection or indentation defined by the vessel.

4. A method according to claim 1, wherein the reference feature comprises a surface mark on the vessel.

5. A method according to claim 1, wherein the images of the reference feature and the first boundary are contained in a single composite image.

6. A method according to claim 1, wherein the images of the reference feature and first boundary are separate images taken simultaneously or consecutively.

7. A method according to claim 1, wherein said images are captured during general illumination of at least the first fraction within the sample and the reference feature.

8. A method according to claim 7, wherein said general illumination is directed at substantially the entire depth of the liquid sample within the vessel.

9. A method according to claim 1, wherein the method further comprises determining the volume of said first fraction with reference to the separation of the first boundary from the reference feature.

10. A method according to claim 1, wherein a further image is captured of a second boundary of the first fraction and the separation between the first and second boundaries of the first fraction determined.

11. A method according to claim 10, wherein the images of the first and second boundaries are contained in a single composite image.

12. A method according to claim 10, wherein the images of the first and second boundaries are separate images taken simultaneously or consecutively.

13. A method according to claim 10, wherein the images of the first and second boundaries of the first fraction are captured during directed illumination of said first and second boundaries within the sample.

14. A method according to claim 13, wherein said directed illumination is provided by at least one light source arranged to direct light on to said first and second boundaries, said light source being offset from the level of said first and second boundaries.

15. A method according to claim 10, wherein the method further comprises determining the volume of said first fraction with reference to the separation between the first and second boundaries of the first fraction.

16. A method according to claim 1, wherein a first further image is captured of a second boundary between second and third fractions within the sample and the separation of the second boundary from the reference feature determined.

17. A method according to claim 16, wherein the images of the first and second boundaries are contained in a single composite image.

18. A method according to claim 16, wherein the images of the first and second boundaries are separate images taken simultaneously or consecutively.

19. A method according to claim 16, wherein the images of the first and second boundaries are captured during general illumination of at least the first and second fractions within the sample and the reference feature.

20. A method according to claim 19, wherein said general illumination is directed at substantially the entire depth of the liquid sample within the vessel.

21. A method according to claim 16, wherein the volume of the second fraction is calculated using the determined separation of the second boundary from the reference feature.

22. A method according to claim 16, wherein a second further image is captured of a third boundary between the first and third fractions within the sample and the separation of the third boundary from the reference feature determined.

23. A method according to claim 22, wherein the images of the second and third boundaries are contained in a single composite image.

24. A method according to claim 22, wherein the images of the second and third boundaries are separate images taken simultaneously or consecutively.

25. A method according to claim 22, wherein the second further image is captured during directed illumination of said third boundary within the sample.

26. A method according to claim 25, wherein said directed illumination is provided by at least one light source arranged to direct light on to said third boundary, said light source being offset from the level of said first and second boundaries.

27. A method according to claim 22, wherein the difference between the separation of the first boundary from the reference feature and the third boundary from the reference feature is determined, and said difference used to calculate the separation of the first boundary from the third boundary.

28. A method according to claim 27, wherein the volume of the first fraction is calculated from the determined separation of the first boundary from the third boundary.

29. A method according to claim 22, wherein the difference between the separation of the second boundary from the reference feature and the third boundary from the reference feature is determined and used to calculate the separation of the second boundary from the third boundary.

30. A method according to claim 29, wherein the volume of the third fraction is calculated using the determined separation of the second boundary from the third boundary.

31. A method according to claim 1, wherein the method further comprises capturing a vessel identification mark within an image.

32. A method according to claim 31, wherein said vessel identification mark identifies information relating to dimensions of the vessel and/or information relating to the sample within the vessel.

33. A method according to claim 32, wherein said vessel identification mark is a barcode affixed to the vessel.

34. A method of aspirating liquid from a fraction of a fractionated liquid sample within a vessel having a reference feature, the method comprising capturing an image of the reference feature and an image of a first boundary of a first fraction within the sample, analysing the captured images to determine the separation of the first boundary from the reference feature of the vessel, determining a volume of the first fraction with reference to the separation of the first boundary from the reference feature, and aspirating said liquid from the first fraction.

35. A method of aspirating liquid from a fraction of a fractionated liquid sample within a vessel having a reference feature, the method comprising capturing an image of the reference feature and an image of a first boundary of a first fraction within the sample, the method further comprising capturing a further image of a second boundary of the first fraction within the sample, analysing the captured images to determine the separation between the first and second boundaries, determining a volume of the first fraction with reference to the separation of the first and second boundaries of the first fraction, and aspirating said liquid from the first fraction.

36. A method of aspirating liquid from a fraction of a fractionated liquid sample within a vessel having a reference feature, the method comprising capturing an image of the reference feature and an image of a first boundary of a first fraction within the sample, the method further comprising capturing a first further image of a second boundary between the first fraction and an adjacent fraction within the sample, capturing a second further image of a third boundary between said adjacent fraction and a further fraction within the sample, analysing the captured first and second further images to determine the separation of the second and third boundaries from the reference feature, determining the difference between the separation of the second and third boundaries from the reference feature, using the difference to calculate the separation of the second boundary from the third boundary, calculating the volume of said adjacent fraction from the calculated separation of the second boundary from the third boundary, and aspirating said liquid from said adjacent fraction.

37. Apparatus for analysing a fractionated liquid sample, the apparatus comprising a support for a vessel having a reference feature containing said fractionated liquid sample, an image capture device arranged to capture an image of the reference feature of said vessel and an image of a first boundary of a first fraction within said sample, and an image analysis device adapted to analyse the captured images and determine the separation of the first fraction boundary from the reference feature.

38. Apparatus according to claim 37, wherein the apparatus further comprises an alignment block to aid correct alignment of the vessel containing the sample relative to the image capture device.

39. Apparatus according to claim 38, wherein the alignment block incorporates guides arranged to abut a lower section of the vessel whilst the vessel is supported by the support.

40. Apparatus according to claim 39, wherein the guides are spaced apart to define a clearance through which the image capture device can view the reference feature.

41. Apparatus for analysing a fractionated liquid sample and aspirating liquid from said sample, the apparatus comprising a support for a vessel having a reference feature containing said fractionated liquid sample, an image capture device arranged to capture an image of the reference feature and an image of a first boundary of a first fraction within said sample, an image analysis device adapted to analyse the captured images and determine the separation of the first fraction boundary from the reference feature of the vessel, and an aspiration device to aspirate a desired amount of liquid from said first fraction.
